(19) United States
(12) Patent Application Publication
(10) Pub. No.: US 2026/0222894 A1
(43) Pub. Date: Jul. 30, 2026

(54) SHARED FLOW CONTROL INDICATION FOR UPLINK TRAFFIC ASSOCIATED WITH NETWORK SESSION

(71) Applicant: QUALCOMM Incorporated, San Diego, CA (US)

(72) Inventors: Panyala Chandra SHEKAR REDDY, Hyderabad (IN); Manoj KUMAR, Hyderabad (IN); Yughandhar KAMAVARAM, Hyderabad (IN)

(21) Appl. No.: 19/036,859

(22) Filed: Jan. 24, 2025

(51) Int. Cl. H04W 28/02

(52) U.S. Cl. CPC H04W 28/0263; H04W 28/0268

(57) ABSTRACT

Various aspects of the present disclosure generally relate to wireless communication. In some aspects, a user equipment (UE) may obtain a flow control status for uplink traffic associated with a data radio bearer (DRB) mapped to a network session. The UE may generate a flow control indication for uplink traffic associated with the network session in accordance with the flow control status associated with the DRB. The UE may apply the flow control indication to uplink traffic associated with multiple DRBs mapped to the network session. Numerous other aspects are described.

### FIELD OF THE DISCLOSURE

Aspects of the present disclosure generally relate to wireless communication and specifically relate to techniques, apparatuses, and methods associated with a shared flow control indication for uplink traffic associated with a network session.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In a wireless communication system, a user equipment (UE) may communicate with a network node to establish a network session that provides end-to-end user plane connectivity between the UE and a data network via a core network. For example, the UE may establish a protocol data unit (PDU) session or a packet data network (PDN) session associated with one or more quality of service (QoS) flows and one or more QoS rules that define parameters related to user plane traffic exchanged between the UE and the data network. For example, each QoS flow is associated with a QoS flow identifier (QFI) that uniquely identifies the QoS flow and one or more QoS flow parameters (e.g., a resource type, such as guaranteed bit rate (GBR), non-GBR, or delay-critical GBR), a default priority level, a packet delay budget (PDB), a packet error rate (PER), a default maximum data burst volume, and/or a default averaging window). In addition, the PDU or PDN session may be associated with one or more QoS rules that indicate one or more packet filters (e.g., whitelist parameters) and may optionally be associated with the QoS flow parameters defined at the QoS flow level.

Accordingly, parameters related to the QoS flows and QoS rules associated with a PDU or PDN session may be provided to the UE and to one or more core network nodes to implement and enforce the QoS flow parameters and QoS rules for traffic associated with the PDU or PDN session (e.g., where the UE and/or the core network node(s) may drop any downlink and/or uplink packets that do not satisfy the appropriate parameters). Furthermore, at a radio access network (RAN) node, one or more data radio bearers (DRBs) may be mapped to the PDU or PDN session, where each DRB is mapped to or otherwise associated with one or more QFIs that control packet treatment on a radio interface between the UE and the RAN node. In this way, each user plane packet exchanged between the UE and the network node is carried over the radio interface via a DRB and over the core network via a QoS flow, which are associated with the same QFI to ensure consistent and uniform end-to-end treatment.

### SUMMARY

Some aspects described herein relate to a user equipment (UE) for wireless communication. The UE may include one or more memories and one or more processors coupled to the one or more memories. The one or more processors may be configured to obtain a flow control status for uplink traffic associated with a data radio bearer (DRB) mapped to a network session. The one or more processors may be configured to generate a flow control indication for uplink traffic associated with the network session in accordance with the flow controlstatus associated with the DRB. The one or more processors may be configured to apply the flow control indication to uplink traffic associated with multiple DRBs mapped to the network session.

Some aspects described herein relate to a method of wireless communication performed by a UE. The method may include obtaining a flow control status for uplink traffic associated with a DRB mapped to a network session. The method may include generating a flow control indication for uplink traffic associated with the network session in accordance with the flow control status associated with the DRB. The method may include applying the flow control indication to uplink traffic associated with multiple DRBs mapped to the network session.

Some aspects described herein relate to a non-transitory computer-readable medium that stores a set of instructions for wireless communication by a UE. The set of instructions, when executed by one or more processors of the UE, may cause the UE to obtain a flow control status for uplink traffic associated with a DRB mapped to a network session. The set of instructions, when executed by one or more processors of the UE, may cause the UE to generate a flow control indication for uplink traffic associated with the network session in accordance with the flow control status associated with the DRB. The set of instructions, when executed by one or more processors of the UE, may cause the UE to apply the flow control indication to uplink traffic associated with multiple DRBs mapped to the network session.

Some aspects described herein relate to an apparatus for wireless communication. The apparatus may include means for obtaining a flow control status for uplink traffic associated with a DRB mapped to a network session. The apparatus may include means for generating a flow control indication for uplink traffic associated with the network session in accordance with the flow control status associated with the DRB. The apparatus may include means for applying the flow control indication to uplink traffic associated with multiple DRBs mapped to the network session.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a user plane protocol stack and a control plane protocol stack for a network node and a core network in communication with a user equipment (UE), in accordance with the present disclosure.

FIG. 4 is a diagram illustrating an example of a network session mapped to one or more data radio bearers (DRBs), in accordance with the present disclosure.

FIG. 5 is a diagram illustrating an example of quality of service (QoS) for one or more network sessions, in accordance with the present disclosure.

FIG. 6 is a diagram illustrating an example of separate flow control indications associated uplink traffic for each DRB associated with a network session, in accordance with the present disclosure.

FIG. 7 is a diagram illustrating an example associated with a shared flow control indication associated with uplink traffic for a network session, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless communication system, a user equipment (UE) may communicate with a network node to establish a network session that provides end-to-end user plane connectivity between the UE and a data network via a core network. For example, the UE may establish a protocol data unit (PDU) session or a packet data network (PDN) session associated with one or more quality of service (QoS) flows and one or more QoS rules that define parameters related to user plane traffic exchanged between the UE and the data network. For example, each QoS flow is associated with a QoS flow identifier (QFI) that uniquely identifies the QoS flow and one or more QoS flow parameters (e.g., a resource type, such as guaranteed bit rate (GBR), non-GBR, or delay-critical GBR), a default priority level, a packet delay budget (PDB), a packet error rate (PER), a default maximum data burst volume, and/or a default averaging window). In addition, the PDU or PDN session may be associated with one or more QoS rules that indicate one or more packet filters (e.g., whitelist parameters) and may optionally be associated with the QoS flow parameters defined at the QoS flow level.

Accordingly, parameters related to the QoS flows and QoS rules associated with a PDU or PDN session may be provided to the UE and to one or more core network nodes to implement and enforce the QoS flow parameters and QoS rules for traffic associated with the PDU or PDN session (e.g., where the UE and/or the core network node(s) may drop any downlink and/or uplink packets that do not satisfy the appropriate parameters). Furthermore, at a radio access network (RAN) node, one or more data radio bearers (DRBs) may be mapped to the PDU or PDN session, where each DRB is mapped to or otherwise associated with one or more QFIs that control packet treatment on a radio interface between the UE and the RAN node. In this way, each user plane packet exchanged between the UE and the network node is carried over the radio interface via a DRB and over the core network via a QoS flow, which are associated with the same QFI to ensure consistent and uniform end-to-end treatment.

In some examples, a UE may be equipped with a modem that may be coupled to a radio, one or more RF chains, one or more transceivers, and one or more antennas to enable wireless communication with a network node over a wireless access link. In addition, the UE may run a high-level operating system (HLOS) that provides a software layer to connect the modem to one or more applications associated with packets communicated over the wireless access link. For example, packets that are transmitted or received over the wireless access link may travel between the modem and HLOS via a hardware path that includes one or more components (e.g., an Internet Protocol (IP) accelerator) that can perform various network functions (e.g., routing, filtering, network address translation, and/or aggregation) without using application processor resources. Alternatively, packets may travel between the modem and the HLOS via a software path when a network state and/or an internal state associated with the modem changes (e.g., because the components in the hardware path are configured according to the network state and/or internal state modem state prior to the change).

Accordingly, in a multi-DRB scenario, where multiple DRBs are established for a PDU or PDN session, the software path between the HLOS and the modem may be flooded with flow control indications associated with uplink grant when a network state change or an internal modem state change occurs. For example, because the network state change or internal modem state change may impact all DRBs associated with a PDU or PDN session, a flow control indication that enables or disables uplink traffic for a flow associated with the PDU or PDN session as a whole may flood the software path between the HLOS and the modem with flow control indications per DRB associated with the PDU or PDN session (e.g., via protocol message exchanges between the modem and the HLOS). For example, when the modem obtains a flow control indication applicable to uplink traffic associated with a PDU or PDN session mapped to N DRBs (e.g., based on a network state change or an internal modem state change), the modem would send N separate flow control indications for uplink traffic to the HLOS via protocol message exchanges over the software path, which may increase processor cycles, increase power consumption, and degrade performance at the UE.

Various aspects relate generally to a shared flow control indication for uplink traffic associated with a network session. Some aspects more specifically relate to techniques whereby a modem associated with a UE may send a single flow control indication to an HLOS when a flow control status change is applicable to an entire PDU or PDN session. For example, when the modem obtains a flow control status that applies to the whole PDU or PDN session, the modem may update a modem processor memory to send flow control indications to the HLOS per PDU or PDN session, rather than sending flow control indications for uplink traffic per DRB. For example, in some aspects, the modem may generate a unique bearer identifier associated with the PDU or PDN session (e.g., the unique bearer identifier applies to all DRBs associated with the PDU or PDN session), such that a flow control indication with the unique bearer identifier may be used to notify the HLOS that the flow control indication applies to the whole PDU or PDN session. In this way, the HLOS may enable or disable transmit and/or receive queues or flows associated with all active DRBs associated with the PDU or PDN session when a flow control indication with the unique bearer identifier is received from the modem. In this way, rather than sending N separate flow control indications associated with uplink traffic for all DRBs to the HLOS running on an application processor when a flow control status applies to the whole PDU or PDN session, the modem may send only one flow control indication to the HLOS when a flow control status applies to the whole PDU or PDN session, which may significantly reduce processor cycles, conserve power, and/or improve performance at the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

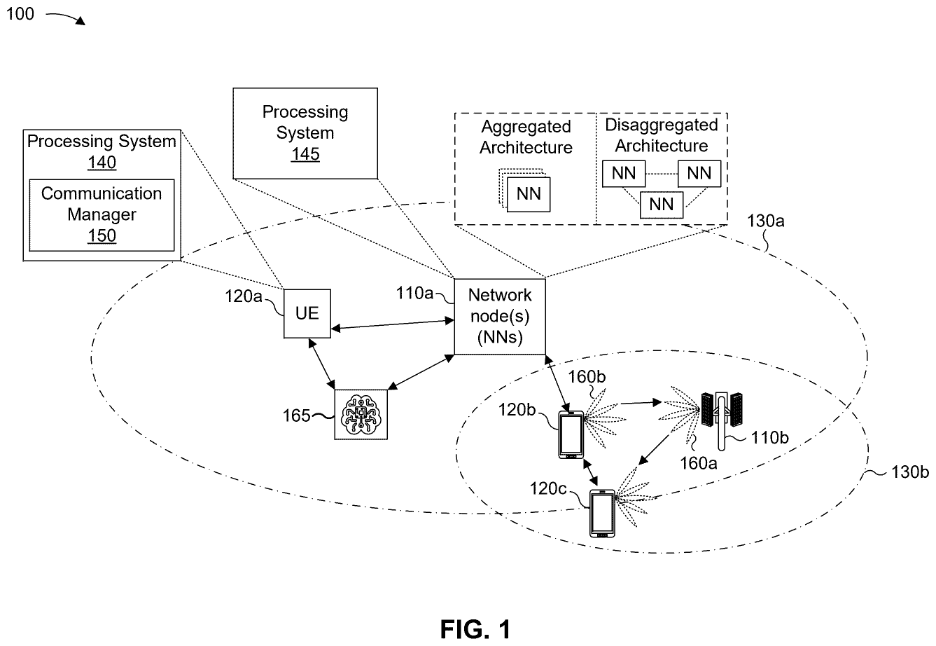

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can

refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

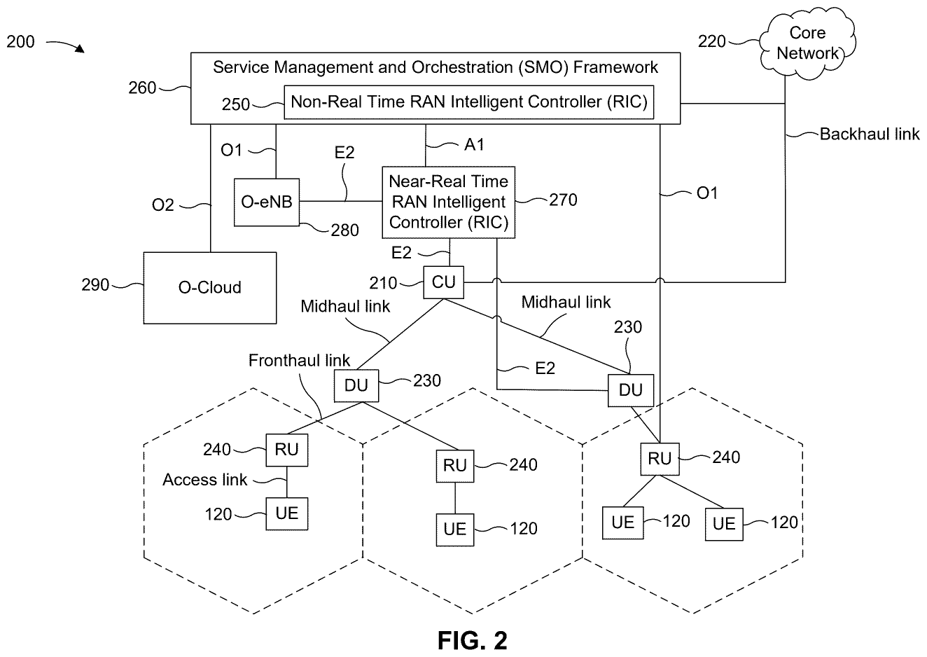

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may obtain a flow control status for uplink traffic associated with a DRB mapped to a network session; generate a flow control indication for uplink traffic associated with the network session in accordance with the flow control status associated with the DRB; and apply the flow control indication to uplink traffic associated with multiple DRBs mapped to the network session. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

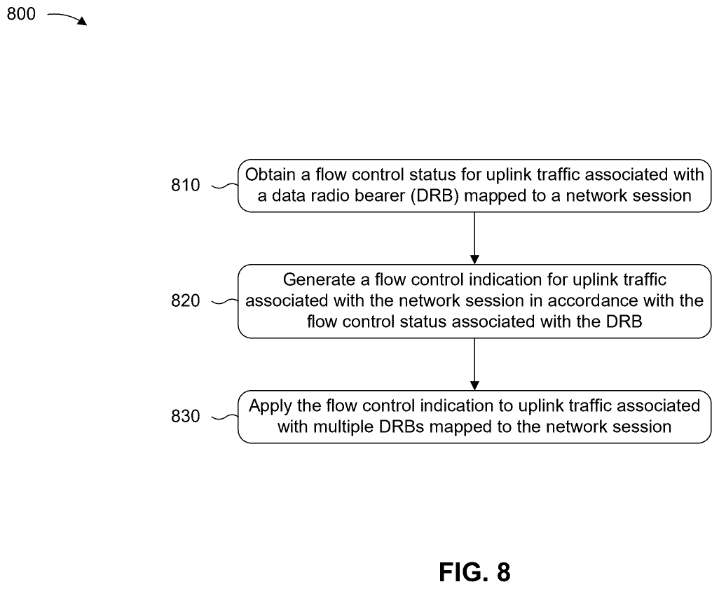

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a shared flow control indication for uplink traffic associated with a network session, as described in more detail elsewhere herein. For example, the processing system 145 of the network node 110, the processing system 140 of the UE 120, the CU 210, the DU 230, or the RU 240 may perform or direct operations of, for example, process 800 of FIG. 8 or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8 or other processes as described herein. In some examples, executing instructions may include running the instructions, converting the instructions, compiling the instructions, and/or interpreting the instructions, among other examples.

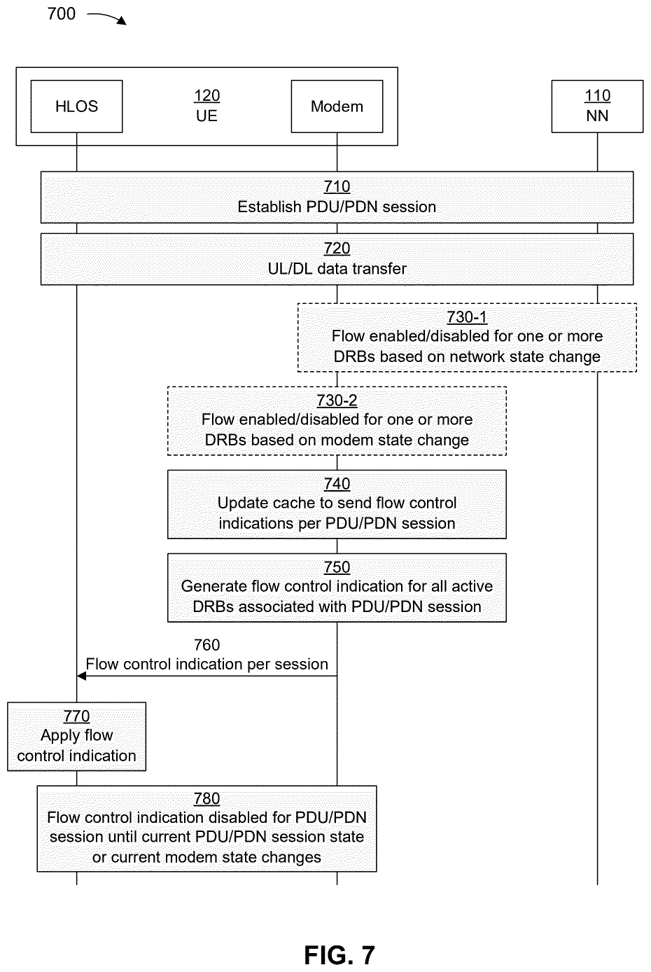

In some aspects, the UE 120 includes means for obtaining a flow control status for uplink traffic associated with a DRB mapped to a network session; means for generating a flow control indication for uplink traffic associated with the network session in accordance with the flow control status associated with the DRB; and/or means for applying the flow control indication to uplink traffic associated with multiple DRBs mapped to the network session. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

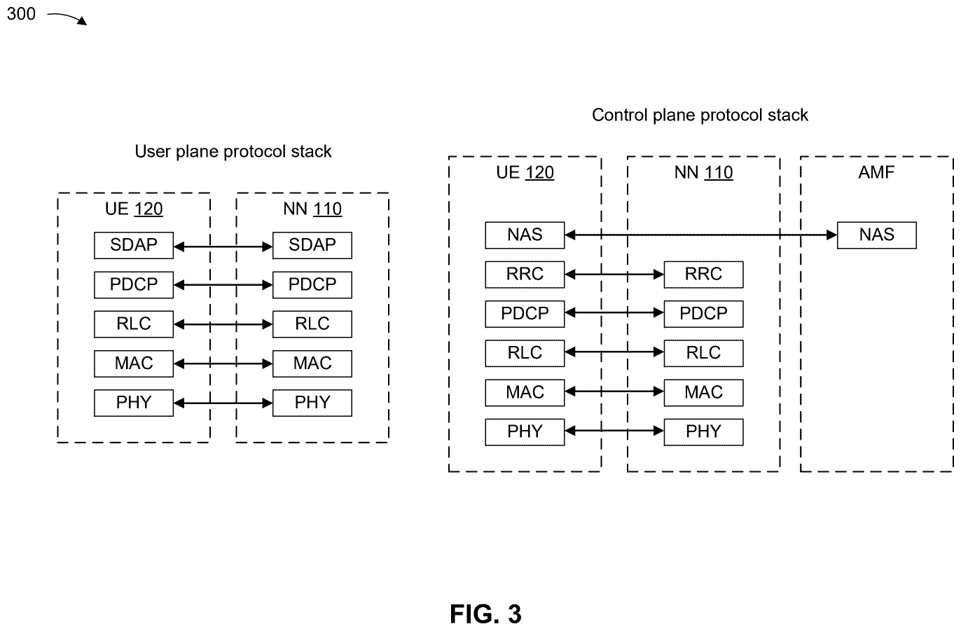

FIG. 3 is a diagram illustrating an example 300 of a user plane protocol stack and a control plane protocol stack for a network node 110 and a core network in communication with a UE 120, in accordance with the present disclosure. In some aspects, the network node 110 may include a plurality of network nodes 110 (e.g., a DU and an RU). In some aspects, protocol stack functions of the network node 110 may be distributed across multiple network nodes 110. For example, a first network node 110 (e.g., a CU) may implement a first layer of a protocol stack and a second network node (e.g., a DU) 110 may implement a second layer of the protocol stack. The distribution of the protocol stack across network nodes 110 (in examples where the protocol stack is distributed across network nodes 110) may be based at least in part on a functional split, as described elsewhere herein.

On the user plane, the UE 120 and the network node 110 may include respective PHY layers, MAC layers, RLC layers, PDCP layers, and SDAP layers. A user plane function (UPF) may handle transport of user data between the UE 120 and the network node 110. On the control plane, the UE 120 and the network node 110 may include respective RRC layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE 120 and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 3, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120. For example, the RRC layer may broadcast system information related to the access stratum (AS) and the NAS, transmit paging initiated by the core network, establish, maintain, and/or release an RRC connection between the UE 120 and the core network, including addition, modification, and/or release of carrier aggregation or dual connectivity, perform security functions (e.g., key management), perform bearer management functions such as establishment, configuration, maintenance, and release of signaling radio bearers (SRBs) and DRBs, perform mobility functions (e.g., handover and context transfer, UE cell selection and reselection and control of cell selection and reselection, and/or inter-RAT mobility), perform QoS management functions, control UE measurement and reporting, support detection and recovery from radio link failure (RLF), and/or transfer NAS messages between the NAS layer and the lower layers of the UE 120. The RRC layer is frequently referred to as Layer 3(L3).

The SDAP layer, the PDCP layer, the RLC layer, and the MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QFI, which identifies the QoS flow. Policy and charging parameters are enforced at the QoS flow granularity. A QoS flow can include one or more service data flows (SDFs), and each SDF of a QoS flow is associated with the same policy and charging parameters. In some aspects, the RRC/NAS layer may generate control information to be transmitted and may map the control information to one or more radio bearers (e.g., SRBs and/or DRBs) for provision to the PDCP layer.

The SDAP layer, or the RRC/NAS layer, may map QoS flows or control information to radio bearers. Thus, the SDAP layer may handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP PDU routing (in case of split bearers), retransmission of PDCP service data units (SDUs), ciphering and deciphering, PDCP SDU discard (e.g., in accordance with a timer), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer), multiplexing/demultiplexing of MAC SDUs belonging to one or different logical channels into/from TBs delivered to/from the PHY layer on transport channels, scheduling information reporting, error correction through hybrid ARQ (HARQ), priority handling between UEs 120 via dynamic scheduling, priority handling between logical channels of one UE 120 via logical channel prioritization, and/or padding.

The MAC layer may package data from logical channels into TBs, and may provide the TBs on one or more transport channels to the PHY layer. The PHY layer may handle various operations relating to transmission of a data signal. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 3 is provided as an example. Other examples may differ from what is described with regard to FIG. 3.

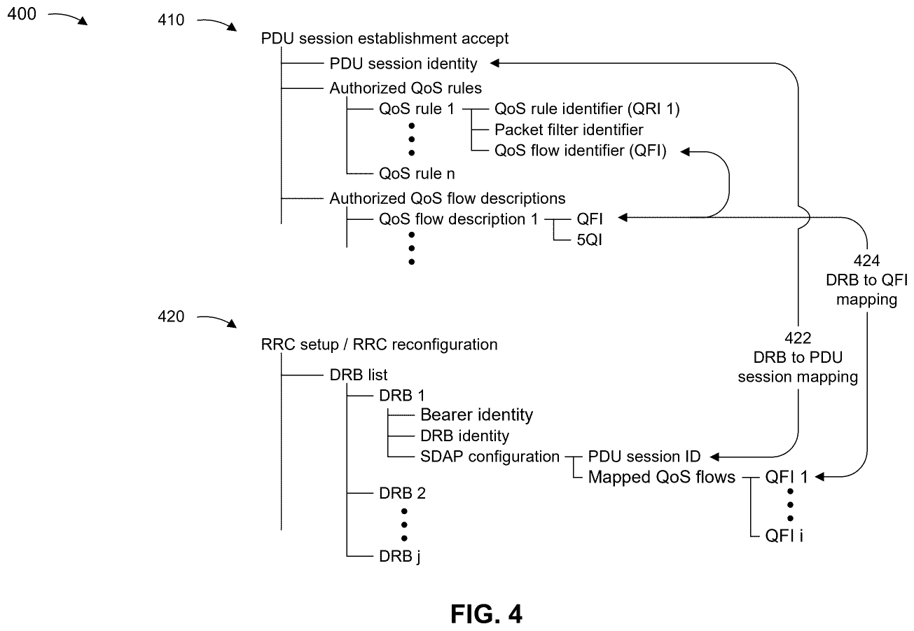

FIG. 4 is a diagram illustrating an example 400 of a network session mapped to one or more DRBs, in accordance with the present disclosure. For example, reference number 410 depicts example parameters associated with a message that a network node 110 may transmit to a UE 120 in response to the UE 120 requesting a network session, and reference number 420 depicts example parameters associated with a message that the network node 110 may transmit to the UE 120 to map one or more DRBs to the network session. For example, as shown by reference number 410, the network node 110 may transmit, and the UE 120 may receive, a PDU session establishment accept message in response to the UE 120 requesting a PDU session. As described herein, the PDU session establishment accept message may configure one or more authorized QoS rules and one or more authorized QoS flows that are used to transport traffic associated with one or more Internet Protocol (IP) flows. For example, as shown in FIG. 4, the PDU session establishment accept message may indicate a PDU session identity to identify the PDU session, and may indicate one or more QoS flow descriptions that are each associated with a QFI and a set of QoS identifiers that indicate one or more QoS parameters associated with the QoS flow (e.g., a resource type, a default priority level, a PDB, a PER, a maximum data burst volume, an averaging window, or the like). In addition, each authorized QoS rule is associated with a QoS rule identifier, a packet filter identifier, and a QoS flow identifier that may correspond to the QFI associated with one of the authorized QoS flow descriptions.

Accordingly, when the network node 110 may provides the UE 120 with an RRC configuration (e.g., in an RRC setup or RRC reconfiguration message), the RRC configuration may configure one or more DRBs that are each associated with a DRB-to-QFI mapping. For example, as shown in FIG. 4, the RRC configuration may configure a set of DRBs, where each DRB is associated with a bearer identity (e.g., an EPS bearer identity), a DRB identity, and an SDAP configuration that indicates the DRB-to-QFI mapping. For example, as shown by reference number 422, the SDAP configuration associated with a DRB indicates a mapping to a PDU session. In addition, as shown by reference number 424, the SDAP configuration associated with a DRB indicates a mapping to one or more QFIs that are each associated with a respective QoS flow. Accordingly, downlink application packets are classified or mapped to suitable QoS flows by a UPF, and uplink application packets are classified or mapped to suitable QoS flows by the UE 120. For example, on an interface between the UPF and a network node 110 on a RAN or other access network, packets are marked with a QFI in an encapsulation header, where the QFI marking indicates to the network node 110 which packets belong to which QoS flow. The SDAP sublayer in the network node 110 maps the flows to suitable DRBs. At the receiving end, the SDAP sublayer at the UE 120 performs a reverse mapping from DRBs to QoS flows. On an uplink, a similar flow occurs, where the UE 120 marks an uplink packet with a QFI in an SDAP header, the network node 110 performs a QFI marking in an encapsulation header on the interface between the network node 110 and the UPF. The UPF then verifies whether a received QFI is aligned with one or more configured QoS rules or reflective QoS.

As indicated above, FIG. 4 is provided as an example. Other examples may differ from what is described with regard to FIG. 4.

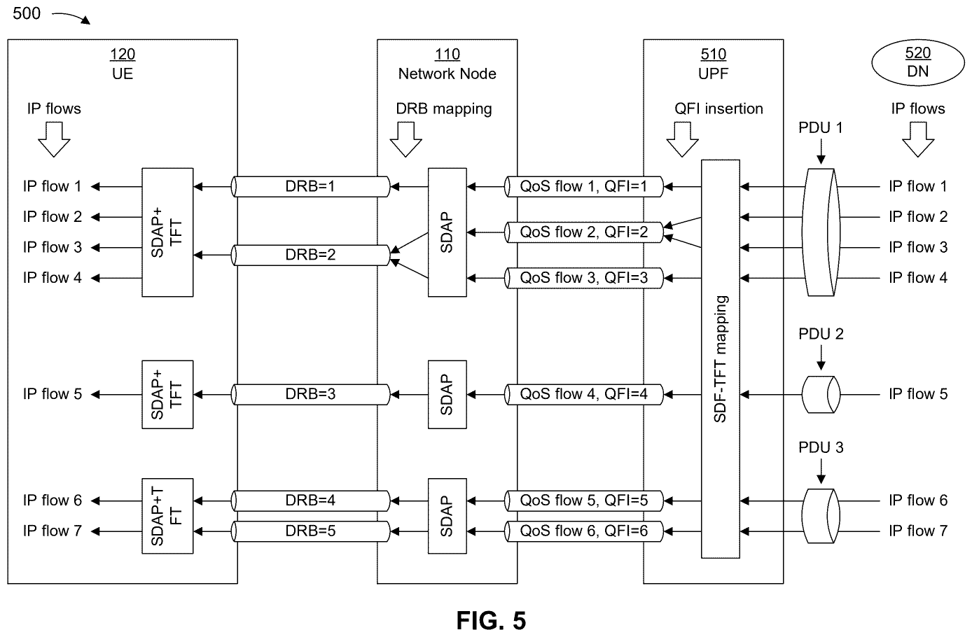

FIG. 5 is a diagram illustrating an example 500 of QoS for one or more network sessions, in accordance with the present disclosure. As shown in FIG. 5, example 500 includes communication between a network node 110, a UE 120, a UPF 510, and a data network 520. In some aspects, in FIG. 5, the UE 120 has established multiple PDU sessions that are each associated with one or more QoS flows, where each QoS flow is associated with one or more IP flows. Furthermore, the PDU sessions are each mapped to one or more DRBs that are each mapped to one or more QoS flows.

For example, FIG. 5 illustrates an example scenario where the UE 120 has established multiple PDU sessions that are each generating packets that may have different QoS requirements. For example, a first PDU session may be transporting packets associated with an Internet session in which the UE 120 may be browsing a website. streaming video, and/or downloading a large file, where delay and jitter may be important for the streaming video but less important for the file download.

Between the UE 120 and the data network 520, PDU sessions and service data flows (SDFs) are configured, and each application is associated with an SDF. In the example 500 shown in FIG. 5, the first PDU session may be associated with Internet traffic, the second PDU session may be associated with streaming video traffic, and the third PDU session may be associated with voice and video IP multimedia subsystem (IMS) traffic. In the illustrated example, the Internet PDU session has four SDFs, the IMS PDU session has two SDFs, and the streaming video PDU session has one SDF. As shown in FIG. 5, multiple IP flows can be mapped to the same QoS flow. For example, QoS flow 2 carries both traffic associated with two IP flows. At the UPF 510, QFI insertion is performed to associate each IP flow with a QoS flow to carry the traffic associated with the IP flow between the UPF and the network node 110. On a radio interface between the network node 110 and the UE 120, QoS flows are mapped to DRBs that are configured to deliver the appropriate QoS. Multiple QoS flows can be mapped to a single DRB (e.g. the second DRB in FIG. 5 carries two QoS flows).

As indicated above, FIG. 5 is provided as an example. Other examples may differ from what is described with regard to FIG. 5.

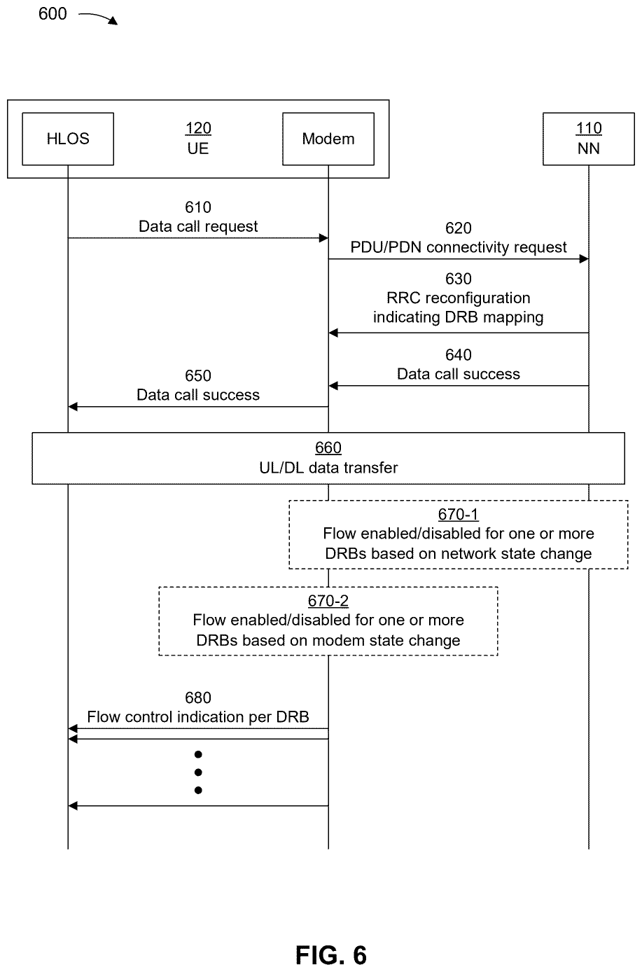

FIG. 6 is a diagram illustrating an example 600 of separate flow control indications associated with uplink traffic for each DRB associated with a network session, in accordance with the present disclosure. As shown in FIG. 6, example 600 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink. Furthermore, as shown in FIG. 6, the UE 120 may include a modem that may be coupled to a radio, one or more RF chains, one or more transceivers, and one or more antennas to enable wireless communication with the network node 110 over the wireless access link, and a high-level operating system (HLOS) that provides a software layer to connect the modem to one or more applications associated with packets communicated over the wireless access link. In some aspects, packets communicated over the wireless access link may be communicated between the modem and HLOS via a hardware path that allows various network functions (e.g., routing, filtering, network address translation, and/or aggregation) to be performed in hardware without using application processor resources, or via a software path in which the network functions bypassed in the hardware path are performed in software (e.g., by a packet-switched routing block).

As shown by reference number 610, the HLOS may send, and the modem may receive (e.g., via a peripheral component interconnect express (PCIe) interface or another suitable interface that connects the HLOS and the modem to a motherboard, chip, or the like), a data call request. For example, the data call request may include or many be triggered by a request to establish user plane data connectivity for one or more applications that are managed by the HLOS. As further shown by reference number 620, the UE 120 may then transmit, via the modem to the network node 110 over the wireless access link, a PDU or PDN connectivity request. For example, the PDU or PDN connectivity request may include a request to establish a PDU or PDN session, and may indicate parameters such as a PDU session type (e.g., IPv4, IPv6, unstructured, or Ethernet), a session and service continuity (SSC) mode related to handling mobility and data flow during an inter-cell or inter-RAT handover, information related to one or more capabilities of the UE 120, a maximum number of supported packet filters, and/or a request type such as an initial network session request, an existing network session request, and/or an emergency network session request, among other examples). The network node 110 may then forward the request to establish the network session to one or more core network nodes (e.g., an AMF, UPF, SMF, mobility management entity (MME), serving gateway (SGW), packet gateway (PGW), or the like).

The one or more core network nodes may then configure one or more QoS flows to carry user plane traffic associated with the PDU or PDN session between the network node 110 and a core network node (e.g., the UPF or PGW). For example, each QoS flow may be associated with a QFI that uniquely identifies the QoS flow and one or more QoS flow parameters (e.g., a resource type, such as GBR, non-GBR, or delay-critical GBR, a default priority level, a PDB, a PER, a default maximum data burst volume, and/or a default averaging window). In addition, the PDU or PDN session may be associated with one or more QoS rules that indicate one or more packet filters (e.g., whitelist parameters) and may optionally be associated with the QoS flow parameters defined at the QoS flow level. Accordingly, parameters related to the QoS flows and QoS rules associated with a PDU or PDN session may be provided to the network node 110 and to one or more core network nodes to implement and enforce the QoS flow parameters and QoS rules for traffic associated with the PDU or PDN session.

As further shown by reference number 630, the network node 110 may transmit, and the UE 120 may receive, a message (e.g., an RRC reconfiguration message) that indicates a DRB-to-QFI mapping established for one or more DRBs mapped to the PDU or PDN session. For example, the network node 110 may configure one or more DRBs to map to the PDU or PDN session, where each DRB is mapped to or otherwise associated with one or more QFIs that control packet treatment on the wireless access link between the UE 120 and the network node 110. In this way, each user plane packet exchanged between the UE 120 and the network node 110 is carried over the radio interface via a DRB and over the core network via a QoS flow, which are associated with the same QFI to ensure consistent and uniform end-to-end treatment. As further shown by reference number 640, the network node 110 may then transmit, and the UE 120 may receive, a message indicating that the data call was successfully established. As further shown by reference number 650, the modem may then communicate with the HLOS to indicate that the data call was successfully established. As further shown by reference number 660, the UE 120 and the network node 110 may then transfer uplink and/or downlink data associated with the PDU or PDN session via the DRBs and QoS flows mapped to the PDU or PDN session. For example, as described herein, uplink and/or downlink data packets may be transported over the wireless access link between the UE 120 and the network node 110 via the DRBs mapped to the PDU or PDN session, and the uplink and/or downlink data packets may be transported between the network node 110 and the core network nodes via the QoS flows mapped to the PDU or PDN session. Furthermore, the DRBs and QoS flows mapped to the PDU or PDN session are each mapped to one or more QFIs to ensure that each packet receives consistent and uniform end-to-end treatment.

As further shown in FIG. 6, the UE 120 may obtain a flow control status for uplink traffic associated with the PDU or PDN session. In some aspects, as described herein, the flow control status may relate to uplink traffic associated with one or more uplink grants (e.g., one or more dynamic grant PUSCH transmissions), and/or may relate to uplink traffic without an uplink grant (e.g., one or more configured grant PUSCH transmissions). In some aspects, the flow control status may be associated with a status change for one or more flows associated with the PDU or PDN session.

For example, as shown by reference number 670-1, the flow control status may change for uplink traffic associated with the one or more flows based on a change to a network state. For example, the flow control status may enable or disable uplink traffic for one or more flows associated with the PDU or PDN session based on a triggering event or condition, such as an out-of-service condition, an RLF event, an event to add one or more DRBs to the DRBs mapped to the PDU or PDN session, an event to delete one or more DRBs from the DRBs mapped to the PDU or PDN session, congestion on the wireless access link or the core network, a modification to the PDU or PDN session, and/or a change to an RRC state (e.g., transitioning from an RRC connected mode to a dormant mode, such as an RRC idle or RRC inactive state, or transitioning from the RRC idle, RRC inactive, or other dormant mode to the RRC connected mode), among other examples. Additionally, or alternatively, as shown by reference number 670-2, the flow control status may change for the one or more flows based on a change to an internal state associated with the modem. For example, the flow control status may enable or disable uplink traffic for one or more flows associated with the PDU or PDN session based on the modem experiencing a memory issue, a packet associated with the PDU or PDN session taking a non-accelerated (e.g., software) path due to hardware limitations or other factors, and/or uplink or downlink buffers being exhausted due to a high data rate, among other examples.

As further shown by reference number 680, the modem may then send flow control indications associated with uplink traffic (e.g., to enable or disable uplink traffic associated with a flow) to the HLOS per DRB. Accordingly, in a multi-DRB scenario, where multiple DRBs are established for the PDU or PDN session, the software path between the HLOS and the modem may be flooded with flow control indications for uplink traffic associated with a PDU or PDN session when a network state change or an internal modem state change is applicable to the PDU or PDN session as a whole. For example, when the network state change or internal modem state change impacts all DRBs associated with a PDU or PDN session, the software path between the HLOS and the modem may be flooded with flow control indications associated with uplink traffic per DRB associated with the PDU or PDN session (e.g., via protocol message exchanges between the modem and the HLOS). For example, when the PDU or PDN session is mapped to N DRBs, a flow control indication based on a network state change or an internal modem state change may result in the modem sending N separate flow control indications associated with uplink traffic to the HLOS via protocol message exchanges over the software path, which may increase processor cycles, increase power consumption, and degrade performance at the UE 120.

As indicated above, FIG. 6 is provided as an example. Other examples may differ from what is described with respect to FIG. 6.

FIG. 7 is a diagram illustrating an example 700 associated with a shared flow control indication for uplink traffic associated with a network session, in accordance with the present disclosure. As shown in FIG. 7, example 700 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink. Furthermore, as shown in FIG. 7, the UE 120 may include a modem that may be coupled to a radio, one or more RF chains, one or more transceivers, and one or more antennas to enable wireless communication with the network node 110 over the wireless access link, and an HLOS that provides a software layer to connect the modem to one or more applications associated with packets communicated over the wireless access link. In some aspects, packets communicated over the wireless access link may be communicated between the modem and HLOS via a hardware path that allows various network functions (e.g., routing, filtering, network address translation, and/or aggregation) to be performed in hardware without using application processor resources, or via a software path in which the network functions bypassed in the hardware path are performed in software (e.g., by a packet-switched routing block).

As shown by reference number 710, the UE 120 may communicate with the network node 110 to establish a PDU or PDN session. For example, as described in more detail above in connection with reference numbers 610 through 650 in FIG. 6, the HLOS may send a data call request to the modem via a PCIe interface or another suitable interface, and the UE 120 may then transmit, via the modem to the network node 110 over the wireless access link, a PDU or PDN connectivity request. The network node 110 may then forward the request to establish the network session to one or more core network nodes that may configure one or more QoS flows to carry user plane traffic associated with the PDU or PDN session between the network node 110 and a core network node that terminates the user plane traffic. For example, each QoS flow may be associated with a QFI that uniquely identifies the QoS flow and one or more QoS flow parameters, and the PDU or PDN session may be associated with one or more QoS rules that indicate one or more packet filters and/or QoS flow parameters defined at the QoS flow level. Accordingly, parameters related to the QoS flows and QoS rules associated with a PDU or PDN session may be provided to the network node 110 and to one or more core network nodes to implement and enforce the QoS flow parameters and QoS rules for traffic associated with the PDU or PDN session.

Furthermore, the network node 110 may configure one or more DRBs that are mapped to the PDU or PDN session, where each DRB is mapped to or otherwise associated with one or more QFIs that control packet treatment on the wireless access link between the UE 120 and the network node 110. Accordingly, the network node 110 may transmit, and the UE 120 may receive, a message (e.g., an RRC reconfiguration message) that indicates a DRB-to-QFI mapping established for one or more DRBs mapped to the PDU or PDN session. In this way, each user plane packet exchanged between the UE 120 and the network node 110 is carried over the radio interface via a DRB and over the core network via a QoS flow, where the DRB and QoS flow are associated with the same QFI to ensure consistent and uniform end-to-end treatment. As further shown by reference number 720, the UE 120 and the network node 110 may then transfer uplink and/or downlink data associated with the PDU or PDN session via the DRBs and QoS flows mapped to the PDU or PDN session. For example, uplink and/or downlink data packets associated with the PDU or PDN session may be transported over the wireless access link between the UE 120 and the network node 110 via the DRBs mapped to the PDU or PDN session, and the uplink and/or downlink data packets may be transported between the network node 110 and the core network nodes via the QoS flows mapped to the PDU or PDN session. Furthermore, the DRBs and QoS flows mapped to the PDU or PDN session are each mapped to one or more QFIs to ensure that each packet receives consistent and uniform end-to-end treatment.

As further shown in FIG. 7, the UE 120 may obtain a flow control status that may indicate a change for one or more flows associated with the PDU or PDN session. In some aspects, the flow control status may impact uplink traffic associated with the one or more flows, where the uplink traffic may be associated with an uplink grant (e.g., one or more dynamic grant PUSCH transmissions) or may not be associated with any uplink grant (e.g., one or more configured grant PUSCH transmissions). For example, as shown by reference number 730-1, the flow control status for uplink traffic may change for the one or more flows based on a change to a network state. For example, the flow control status may enable or disable uplink traffic for one or more flows associated with the PDU or PDN session based on a triggering event or condition, such as an out-of-service condition, an RLF event, an event to add one or more DRBs to the DRBs mapped to the PDU or PDN session, an event to delete one or more DRBs from the DRBs mapped to the PDU or PDN session, congestion on the wireless access link or the core network, a modification to the PDU or PDN session, and/or a change to an RRC state (e.g., transitioning from an RRC connected mode to a dormant mode, such as an RRC idle or RRC inactive state, or transitioning from the RRC idle, RRC inactive, or other dormant mode to the RRC connected mode), among other examples. Additionally, or alternatively, as shown by reference number 730-2, the flow control status for uplink traffic may change for the one or more flows based on a change to an internal state associated with the modem. For example, the flow control status for uplink traffic may enable or disable one or more flows associated with the PDU or PDN session based on the modem experiencing a memory issue, a packet associated with the PDU or PDN session taking a non-accelerated (e.g., software) path due to hardware limitations or other factors, and/or uplink or downlink buffers being exhausted due to a high data rate, among other examples.

In some aspects, as shown by reference number 740, the modem may update a modem memory cache to send flow control indications associated with uplink traffic to the HLOS per PDU or PDN session (rather than per DRB) based on the flow control status satisfying one or more conditions that indicate that the flow control status change applies to uplink traffic associated with the whole PDU or PDN session (e.g., to all DRBs and QoS flows associated with the PDU or PDN session). For example, in some aspects, the modem may determine that the flow control status change applies to uplink traffic associated with the whole PDU or PDN session based on a memory status associated with the modem (e.g., the flow control status change may apply to uplink traffic associated with the whole PDU or PDN session based on the modem having limited memory available for uplink and/or downlink data transfer). Additionally, or alternatively, the flow control status change may apply to uplink traffic associated with the whole PDU or PDN session based on a bearer status or a PDU or PDN status (e.g., the flow control status change may apply to uplink traffic associated with the whole PDU or PDN session based on all DRBs associated with the PDU or PDN session being flow controlled), based on a network procedure that applies to all active DRBs associated with the PDU or PDN session, based on congestion control information received from the network node 110, and/or based on a number of grants from a PHY layer failing to satisfy (e.g., equal or exceed) a threshold, among other examples.

As further shown by reference number 750, the modem may generate a flow control indication applicable to uplink traffic associated with all DRBs associated with the PDU or PDN session. For example, in some aspects, the flow control indication may include a unique bearer identifier that may be associated with the PDU or PDN session to indicate that the flow control indication applies to uplink traffic associated with all active DRBs associated with the PDU or PDN session. In addition, the flow control indication may include an identifier associated with the PDU or PDN session and/or other suitable parameters. As shown by reference number 760, the modem may then send the flow control indication to the HLOS per PDU or PDN session (e.g., one flow control indication for uplink traffic per PDU or PDN session). For example, in addition to monitoring the interface between the HLOS and the modem for flow control indications that carry identifiers associated with uplink traffic carried in individual DRBs, the HLOS may monitor the interface for flow control indications that include the unique identifier(s) associated with the PDU or PDN session(s) mapped to multiple DRBs. Accordingly, as shown by reference number 770, the HLOS may apply the flow control indication to enable or disable uplink traffic associated with all DRBs associated with the PDU or PDN session when the HLOS receives the flow control indication with the unique bearer identifier associated with the PDU or PDN session. For example, the HLOS may enable or disable transmit and/or receive queues or flows associated with all active DRBs associated with the PDU or PDN session when a flow control indication with the unique bearer identifier is received from the modem. Furthermore, as shown by reference number 780, the modem may refrain from sending any further flow control indications for uplink traffic associated with the PDU or PDN session, and all data packets associated with the PDU or PDN session may travel between the HLOS and the modem via the software path, until the current network state changes, the current internal modem state changes, and/or the current PDU or PDN session state changes. In this way, rather than sending N separate flow control indications to the HLOS when a flow control status applies to uplink traffic associated with the whole PDU or PDN session, the modem may send only one flow control indication for uplink traffic to the HLOS when a flow control status applies to uplink traffic associated with the whole PDU or PDN session, which may significantly reduce processor cycles, conserve power, and/or improve performance at the UE 120.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with a shared flow control indication for uplink traffic associated with a network session.

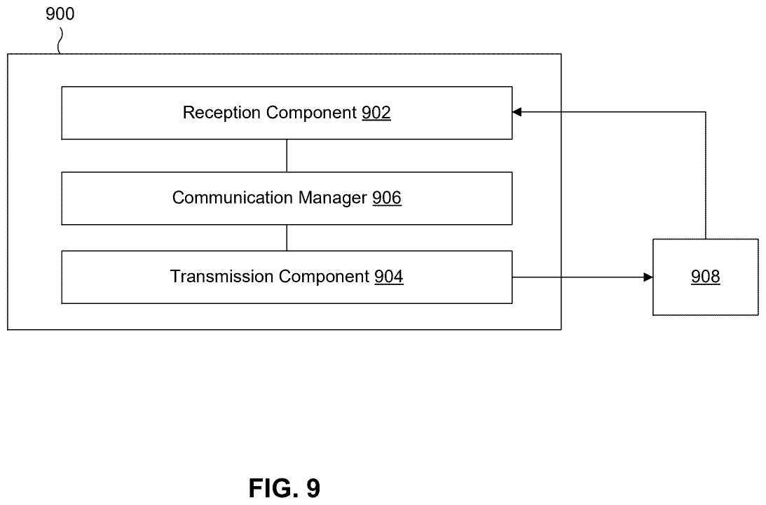

As shown in FIG. 8, in some aspects, process 800 may include obtaining a flow control status for uplink traffic associated with a DRB mapped to a network session (block 810). For example, the UE (e.g., using reception component 902 and/or communication manager 906, depicted in FIG. 9) may obtain a flow control status for uplink traffic associated with a DRB mapped to a network session, as described above.

As further shown in FIG. 8, in some aspects, process 800 may include generating a flow control indication for uplink traffic associated with the network session in accordance with the flow control status associated with the DRB (block 820). For example, the UE (e.g., using communication manager 906, depicted in FIG. 9) may generate a flow control indication for uplink traffic associated with the network session in accordance with the flow control status associated with the DRB, as described above.

As further shown in FIG. 8, in some aspects, process 800 may include applying the flow control indication to uplink traffic associated with multiple DRBs mapped to the network session (block 830). For example, the UE (e.g., using communication manager 906, depicted in FIG. 9) may apply the flow control indication to uplink traffic associated with multiple DRBs mapped to the network session, as described above.

Process 800 may include additional aspects, such as any single aspect or any combination of aspects described below and/or in connection with one or more other processes described elsewhere herein.

In a first aspect, the flow control status is associated with disabling or enabling a flow associated with the DRB based on a change to a wireless network state.

In a second aspect, alone or in combination with the first aspect, the flow control status disables or enables a flow associated with the DRB based on a change to an internal modem state.

In a third aspect, alone or in combination with one or more of the first and second aspects, the flow control indication is applied to uplink traffic associated with the multiple DRBs mapped to the network session in accordance with the flow control status associated with the DRB satisfying one or more conditions.

In a fourth aspect, alone or in combination with one or more of the first through third aspects, the one or more conditions include internal memory available for data transfer failing to satisfy a threshold.

In a fifth aspect, alone or in combination with one or more of the first through fourth aspects, the one or more conditions include flow control being enabled for the multiple DRBs associated with the network session.

In a sixth aspect, alone or in combination with one or more of the first through fifth aspects, the one or more conditions include receiving or transmitting one or more packets associated with a wireless network procedure that applies to the multiple DRBs associated with the network session.

In a seventh aspect, alone or in combination with one or more of the first through sixth aspects, the one or more conditions include receiving congestion control information from a network node.

In an eighth aspect, alone or in combination with one or more of the first through seventh aspects, the one or more conditions include a number of physical layer grants within a time period failing to satisfy a threshold.

In a ninth aspect, alone or in combination with one or more of the first through eighth aspects, process 800 includes disabling flow control status indications for uplink traffic associated with the multiple DRBs mapped to the network session until a current network state changes or a current modem state changes.

In a tenth aspect, alone or in combination with one or more of the first through ninth aspects, the flow control status enables or disables a flow associated with the DRB in accordance with an out-of-service state, an RLF event, or a change to an RRC state.

In an eleventh aspect, alone or in combination with one or more of the first through tenth aspects, the uplink traffic is associated with an uplink grant.

In a twelfth aspect, alone or in combination with one or more of the first through eleventh aspects, the uplink traffic is not associated with an uplink grant.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIG. 7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may obtain a flow control status for uplink traffic associated with a DRB mapped to a network session. The communication manager 906 may generate a flow control indication for uplink traffic associated with the network session in accordance with the flow control status associated with the DRB. The communication manager 906 may apply the flow control indication to uplink traffic associated with multiple DRBs mapped to the network session.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: obtaining a flow control status for uplink traffic associated with a DRB mapped to a network session; generating a flow control indication for uplink traffic associated with the network session in accordance with the flow control status associated with the DRB; and applying the flow control indication to uplink traffic associated with multiple DRBs mapped to the network session.

Aspect 2: The method of Aspect 1, wherein the flow control status is associated with disabling or enabling a flow associated with the DRB based on a change to a wireless network state.

Aspect 3: The method of any of Aspects 1-2, wherein the flow control status disables or enables a flow associated with the DRB based on a change to an internal modem state.

Aspect 4: The method of any of Aspects 1-3, wherein the flow control indication is applied to the uplink traffic associated with multiple DRBs mapped to the network session in accordance with the flow control status associated with the DRB satisfying one or more conditions.

Aspect 5: The method of Aspect 4, wherein the one or more conditions include internal memory available for data transfer failing to satisfy a threshold.

Aspect 6: The method of Aspect 4, wherein the one or more conditions include flow control being enabled for the multiple DRBs associated with the network session.

Aspect 7: The method of Aspect 4, wherein the one or more conditions include receiving or transmitting one or more packets associated with a wireless network procedure that applies to the multiple DRBs associated with the network session.

Aspect 8: The method of Aspect 4, wherein the one or more conditions include receiving congestion control information from a network node.

Aspect 9: The method of Aspect 4, wherein the one or more conditions include a number of physical layer grants within a time period failing to satisfy a threshold.

Aspect 10: The method of any of Aspects 1-9, further comprising: disabling flow control status indications for uplink traffic associated with the multiple DRBs mapped to the network session until a current network state changes or a current modem state changes.

Aspect 11: The method of any of Aspects 1-10, wherein the flow control status enables or disables a flow associated with the DRB in accordance with an out-of-service state, an RLF event, or a change to an RRC state.

Aspect 12: The method of any of Aspects 1-11, wherein the uplink traffic is associated with an uplink grant.

Aspect 13: The method of any of Aspects 1-12, wherein the uplink traffic is not associated with an uplink grant.

Aspect 14: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.

Aspect 15: An apparatus for wireless communication at a device, the apparatus comprising one or more memories and one or more processors coupled to the one or more memories, the one or more processors configured to cause the device to perform the method of one or more of Aspects 1-13.

Aspect 16: An apparatus for wireless communication, the apparatus comprising at least one means for performing the method of one or more of Aspects 1-13.

Aspect 17: A non-transitory computer-readable medium storing code for wireless communication, the code comprising instructions executable by one or more processors to perform the method of one or more of Aspects 1-13.

Aspect 18: A non-transitory computer-readable medium storing a set of instructions for wireless communication, the set of instructions comprising one or more instructions that, when executed by one or more processors of a device, cause the device to perform the method of one or more of Aspects 1-13.

Aspect 19: A device for wireless communication, the device comprising a processing system that includes one or more processors and one or more memories coupled with the one or more processors, the processing system configured to cause the device to perform the method of one or more of Aspects 1-13.

Aspect 20: An apparatus for wireless communication at a device, the apparatus comprising one or more memories and one or more processors coupled to the one or more memories, the one or more processors individually or collectively configured to cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
obtain a flow control status for uplink traffic associated with a data radio bearer (DRB) mapped to a network session;
generate a flow control indication for uplink traffic associated with the network session in accordance with the flow control status associated with the DRB; and
apply the flow control indication to uplink traffic associated with multiple DRBs mapped to the network session.

2. The UE of claim 1, wherein the flow control status is associated with disabling or enabling a flow associated with the DRB based on a change to a wireless network state.

3. The UE of claim 1, wherein the flow control status disables or enables a flow associated with the DRB based on a change to an internal modem state.

4. The UE of claim 1, wherein the flow control indication is applied to uplink traffic associated with the multiple DRBs mapped to the network session in accordance with the flow control status associated with the DRB satisfying one or more conditions.

5. The UE of claim 4, wherein the one or more conditions include internal memory available for data transfer failing to satisfy a threshold.

6. The UE of claim 4, wherein the one or more conditions include flow control being enabled for the multiple DRBs associated with the network session.

7. The UE of claim 4, wherein the one or more conditions include receiving or transmitting one or more packets associated with a wireless network procedure that applies to the multiple DRBs associated with the network session.

8. The UE of claim 4, wherein the one or more conditions include receiving congestion control information from a network node.

9. The UE of claim 4, wherein the one or more conditions include a number of physical layer grants within a time period failing to satisfy a threshold.

10. The UE of claim 1, wherein the one or more processors are further configured to cause the UE to:
disable flow control status indications for uplink traffic associated with the multiple DRBs mapped to the network session until a current network state changes or a current modem state changes.

11. The UE of claim 1, wherein the flow control status enables or disables a flow associated with the DRB in accordance with an out-of-service state, a radio link failure (RLF) event, or a change to a radio resource control (RRC) state.

12. The UE of claim 1, wherein the uplink traffic is associated with an uplink grant.

13. The UE of claim 1, wherein the uplink traffic is not associated with an uplink grant.

14. A method for wireless communication by a user equipment (UE), comprising:
obtaining a flow control status for uplink traffic associated with a data radio bearer (DRB) mapped to a network session;
generating a flow control indication for uplink traffic associated with the network session in accordance with the flow control status associated with the DRB; and
applying the flow control indication to uplink traffic associated with multiple DRBs mapped to the network session.

15. The method of claim 14, wherein the flow control status is associated with disabling or enabling a flow associated with the DRB based on a change to a wireless network state or a change to an internal modem state.

16. The method of claim 14, wherein the flow control indication is applied to uplink traffic associated with the multiple DRBs mapped to the network session in accordance with internal memory available for data transfer failing to satisfy a threshold.

17. The method of claim 14, wherein the flow control indication is applied to uplink traffic associated with the multiple DRBs mapped to the network session in accordance with flow control being enabled for the multiple DRBs associated with the network session.

18. The method of claim 14, wherein the flow control indication is applied to uplink traffic associated with the multiple DRBs mapped to the network session in accordance with receiving or transmitting one or more packets associated with a wireless network procedure that applies to the multiple DRBs associated with the network session.

19. The method of claim 14, wherein the flow control indication is applied to uplink traffic associated with the multiple DRBs mapped to the network session in accordance with a number of physical layer grants within a time period failing to satisfy a threshold.

20. An apparatus for wireless communication, comprising:
means for obtaining a flow control status for uplink traffic associated with a data radio bearer (DRB) mapped to a network session;
means for generating a flow control indication for uplink traffic associated with the network session in accordance with the flow control status associated with the DRB; and
means for applying the flow control indication to uplink traffic associated with multiple DRBs mapped to the network session.
